(19) United States
(12) Patent Application Publication
(10) Pub. No.: US 2014/0356157 A1
(43) Pub. Date: Dec. 4, 2014

(54) WIND TURBINE DEVICE WITH DIVERTER PANELS AND RELATED SYSTEMS AND METHODS

(71) Applicant: UNIVERSAL WIND POWER, LLC, Henderson, CO (US)

(72) Inventors: Rafael D. Mayor, Lakewood, CO (US); Richard T. Barcia, JR., Lakewood, CO (US); Michael O'Donnell, Lakewood, CO (US)

(73) Assignee: UNIVERSAL WIND POWER, LLC, Henderson, CO (US)

(21) Appl. No.: 14/285,906

(22) Filed: May 23, 2014

Related U.S. Application Data
(60) Provisional application No. 61/828,798, filed on May 30, 2013.

(51) Int. Cl. F03D 3/04; F03D 9/00; F03D 3/00; F03D 3/06

(52) U.S. Cl. CPC F03D 3/0409; F03D 3/064; F03D 9/002; F03D 3/005
USPC 415/208.2; 29/889.21

(57) ABSTRACT

A wind turbine device may include turbine blades being radially spaced and extending vertically, diverter panels being respectively adjacent and radially outward of the turbine blades, an inner support ring coupled to the turbine blades, and an axle coupled to the turbine blades.

### RELATED APPLICATIONS

This application is based upon prior filed copending provisional patent application Ser. No. 61/828,798 filed May 30, 2013, the entire subject matter of which is incorporated herein by reference in its entirety.

### TECHNICAL FIELD

The present disclosure relates to the field of wind turbines, and, more particularly, to a vertical axis wind turbine system.

### BACKGROUND

Wind power involves the harnessing and conversion of wind energy into a useful form of energy. Examples include the use of wind turbines to generate electrical power or provide mechanical power to water pumps.

Wind power is an alternative to the use of fossil fuels and is plentiful, renewable and environmentally friendly. With today's increasing demand for renewable energy sources due to environmental concerns and high prices for fossil fuels, the demands for efficiency and effectiveness in wind turbines may increase.

### SUMMARY

In view of the foregoing background, it is therefore an object of the present disclosure to provide a wind turbine device that is efficient and robust.

This and other objects, features, and advantages in accordance with the present disclosure are provided by a wind turbine device that may comprise a plurality of turbine blades being radially spaced and extending vertically, and a plurality of diverter panels being respectively adjacent and radially outward of the plurality of turbine blades. The wind turbine device may also include at least one inner support ring coupled to the plurality of turbine blades, and an axle coupled to the plurality of turbine blades. Advantageously, the wind turbine device may produce energy more efficiently and with reduced turbine blade back pressure.

In particular, each diverter panel may be canted at an angle with respect to the respective turbine blade. Each turbine blade may have a semi-cylinder shape. Adjacent diverter panels may define a wind tunnel for the respective turbine blade.

In some embodiments, the wind turbine device may further comprise a hub coupled to the axle, and a plurality of blade braces extending radially from the hub respectively to the plurality of turbine blades. Also, each diverter panel may be canted at an angle between 30 degrees and 60 degrees with respect to the respective blade brace.

Additionally, the wind turbine device may further comprise at least one outer support ring coupled the plurality of diverter panels. Each diverter panel may have opposing first and second longitudinal ends, and the at least one outer support ring may comprise a plurality thereof having a first outer support ring coupled to the first longitudinal ends of each of the plurality of diverter panels, and a second outer support ring coupled to the second longitudinal ends of each of the plurality of diverter panels. Each turbine blade may have opposing first and second longitudinal ends, and the at least one inner support ring may comprise a plurality thereof having a first inner support ring coupled to the first longitudinal ends of each of the plurality of turbine blades, and a second inner support ring coupled to the second longitudinal ends of each of the plurality of turbine blades.

Another aspect is directed to a wind turbine system. The wind turbine system may comprise a plurality of turbine blades being radially spaced and extending vertically, a plurality of diverter panels being respectively adjacent and radially outward of the plurality of turbine blades, at least one inner support ring coupled to the plurality of turbine blades, and an axle coupled to the plurality of turbine blades. The wind turbine system may also include a generator coupled to the axle, and a frame to be coupled to a surface and carrying the axle and the generator.

Another aspect is directed to a method for making a wind turbine device. The method may comprise coupling a plurality of turbine blades to be radially spaced and extend vertically, coupling a plurality of diverter panels to be respectively adjacent and radially outward of the plurality of turbine blades, coupling at least one inner support ring to the plurality of turbine blades, and coupling an axle to the plurality of turbine blades.

### BRIEF DESCRIPTION OF THE DRAWINGS

FIG. 1 is a side view of a wind turbine system with some turbine blades and diverter panels removed, according to an embodiment of the present disclosure.

FIG. 2 is top plan view of the wind turbine system of FIG. 1.

FIG. 3 is bottom plan view of the wind turbine system of FIG. 1.

FIGS. 4 and 5 are top plan and side elevation views of a turbine blade from the wind turbine system of FIG. 1.

### DETAILED DESCRIPTION

The present disclosure will now be described more fully hereinafter with reference to the accompanying drawings, in which several embodiments of the present disclosure are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout.

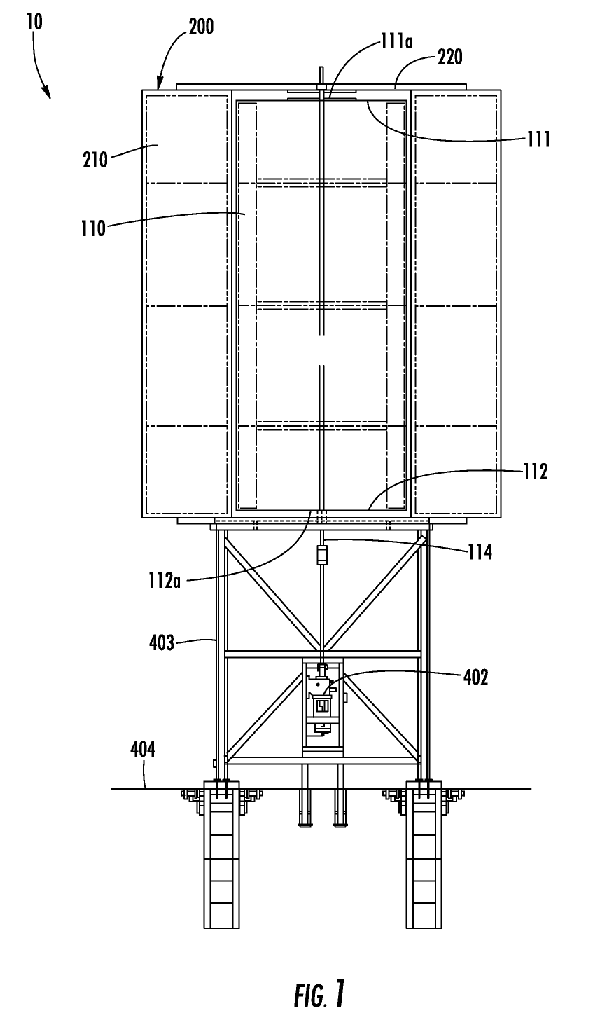

Referring to FIGS. 1-5, a vertical axis wind turbine (VAWT) system 10 according to the present disclosure is now described. The VAWT system 10 includes a wind turbine 100 with a diverter wind diverter assembly 200 arranged along the perimeter of the wind turbine 100. The diverter wind diverter assembly 200 includes a plurality of diverter panels 210a-210n spaced around the perimeter of the wind turbine 100, and the diverter panels 210a-210n are arranged in a stationary manner about turbine blades 110a-110n of the wind turbine 100. The system 10 preferably includes between 10 and 20 diverter panels 210a-210n, most preferably, approximately 14 diverter panels evenly spaced around the perimeter of the system 10 to maximize wind tunneling and capture, as will be explained herein.

The diverter wind diverter assembly 200 includes at least one first diverter top ring 220 that encircles the perimeter of the diverter panels 210a-210n spaced around the perimeter of the wind turbine 100. The at least one first diverter top ring 220 is located at the top of the VAWT system 10 and/or along any point of the outer portion 211 of the diverter panels 210a-210n spanning the vertical length of the diverter panels 210a-210n. Likewise, the VAWT system 10 includes at least one second diverter top ring 230 that encircles the perimeter of the wind turbine 100 (but not attached to the wind turbine 100 or turbine blades 110a-110n) and is attached to the inner portion 212 of the diverter panels 210a-210n.

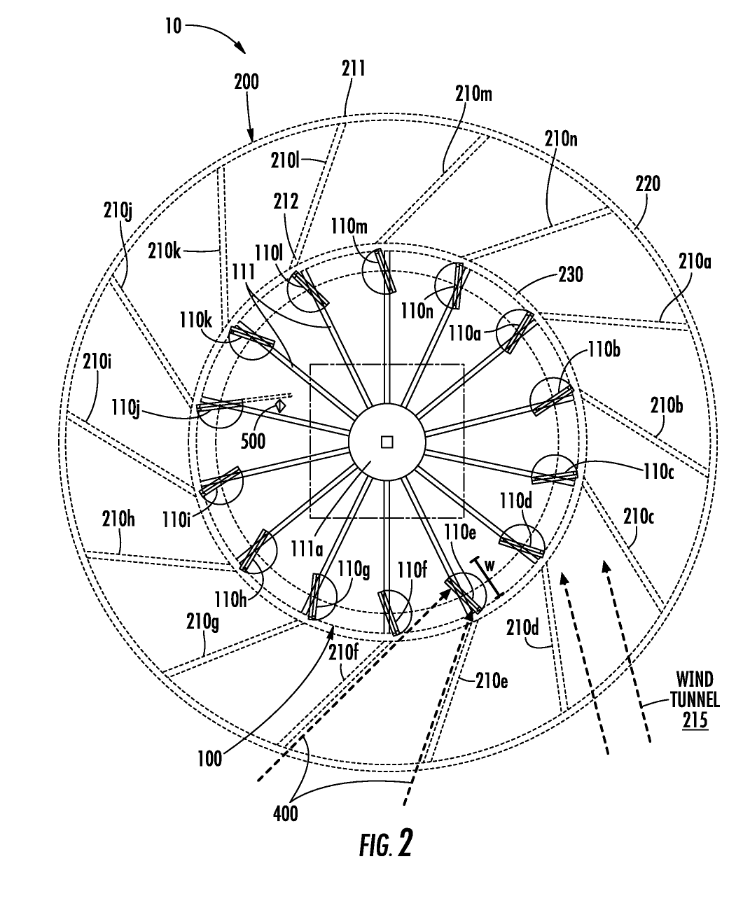

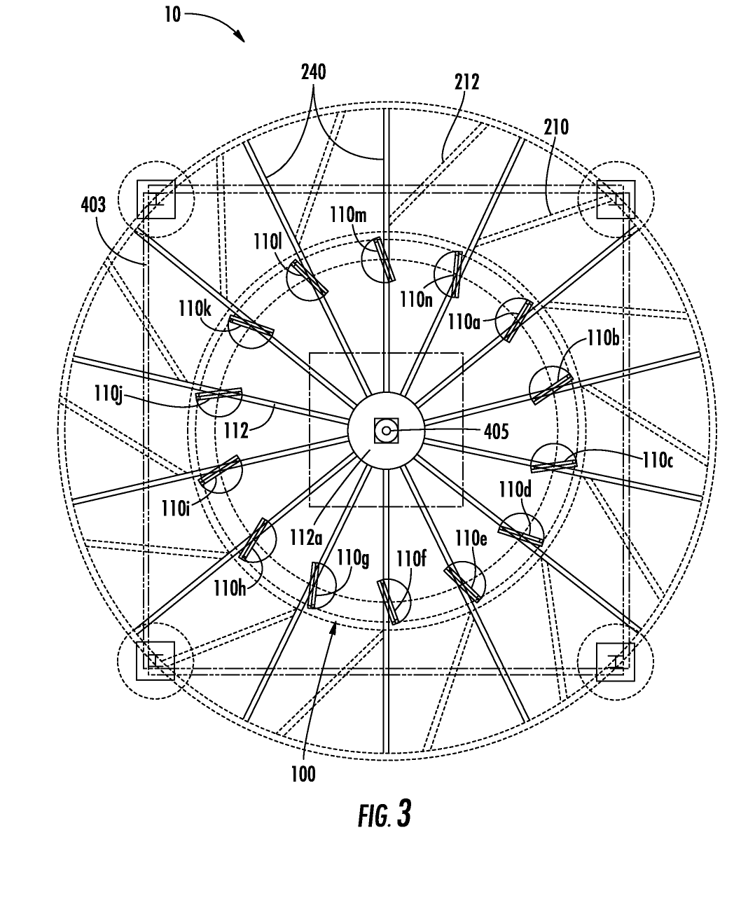

As shown in FIG. 3, the diverter wind diverter assembly 200 optionally includes a plurality of diverter braces 240 extending from a center portion on the top of the VAWT system 10 outward, each contacting the inner portion 212 of respective diverter panels 210a-210n. The diverter panels 210a-210n are oriented at an angle of from about 30 degrees to about 60 degrees from where the diverter braces 240 contact the diverter panels 210a-210n, with a preferable angle of about 44 degrees. The angle of the diverter panels 210a-210n creates a wind tunnel 215 (as illustrated in FIG. 2) and provides a line of site diverting wind directly into the turbine blades 110a-110n. The angled design of the diverter panels 210a-210n increases and maximizes the amount of wind capture by the turbine blades 110a-110n.

The diverter panels 210a-210n additionally function to avoid back pressure from the wind contacting the system 10. If the diverter panels were not present, the wind would contact the turbine blades 110a-110n left of the center of the turbine blades 110a-110n, which creates back pressure, slowing the blade rotation down. The diverter panels 210a-210n further provide structural integrity to the VAWT system 10, limiting the need for additional bracing throughout the system.

Preferably, the overall diameter of the VAWT system 10 as a whole is about 100% to about 150% larger than the diameter of the wind turbine 100. The increased diameter of the VAWT system with the diverter panels in place facilitates diverting more of the available wind. As a non-limiting example, if the diameter of the wind turbine is about 10 feet, a corresponding diameter of the entire VAWT system would be about 22.5 feet.

The turbine blades 110a-110n are attached to turbine braces 111, 112. Each of the turbine braces 111, 112 extends outward from a top or bottom center portion 111a, 112a and attaches to a turbine blade 110a-110n. Turbine braces 111, 112 can optionally be on both the top and bottom of the wind turbine and connect a top or bottom center portion 111a, 112a to the top or bottom, respectively, of the turbine blades 110a-110n.

Each of the turbine blades 110a-110n is angled such that when wind hits the blade, it pushes through a large perimeter of the circular movement of the turbine. As such, the turbine blade 110a-110n is generally angled at about 15 degrees to about 25 degrees from its respective turbine brace 111, 112. Preferably, as shown in FIG. 2 at 500, the turbine blade 110a-110n is angled at about 20 degrees from its respective turbine brace 111, 112. The corresponding center portion 112a on the bottom of the wind turbine additionally connects to a bottom axle 114 that can be in communication with an electrical generation device or a pump mechanism, depending on the application of the VAWT system.

Advantageously, the turbine blades 110a-110n are shaped as a trough-like structure along the length of the blade, as illustrated in FIG. 2, to facilitate capture of wind. The turbine blades 110a-110n are structured to substantially extend the full height of the wind turbine 100. In other embodiments, multiple turbine blades are oriented on top of each other to collectively substantially extend the height of the wind turbine. The width of the turbine blades 110a-110n is such that full wind capture is maximized. The width (w) of the turbine blades 110a-110n is preferably determined by the line of sight 400 (LOS) of adjacent diverter panels 210a-210n, as illustrated in FIG. 2. In other words, the turbine blade 110a-110n is a sufficient width to capture most of the wind that is directed through the adjacent diverter panels 210a-210n, which form the wind tunnel 215. Additionally, the turbine blade 110a-110n is generally not wider than this LOS of adjacent diverter panels 210a-210n to avoid capture and disruption of wind that is directed through the next adjacent set of diverter panels 210a-210n. The turbine blades 110a-110n and diverter panels 210a-210n are formed from a variety of different materials capable of maintaining rigidity and strength, such as but not limited to, steel, galvanized steel, fiberglass, composite materials, aluminum, or combinations thereof.

Additionally, the angled orientation of each of the turbine blades 110a-110n further acts to divert wind from the next blade 110a-110n in the wind turbine 100, thus decreasing the back pressure on each of the turbine blades 110a-110n. In this design, no turbine blade 110a-110n is fully hit by wind on the backside of the blade 110a-110n because at least 50% of the turbine blade 110a-110n is blocked by the next blade 110a-110n in sequence on the wind turbine 100. Furthermore, the curved design of the back of the blades 110a-110n additionally functions to dampen any back pressure that is generated.

In another aspect, the present disclosure is directed to a method of wind capture for conversion of wind energy to useful power. The method includes providing a vertical axis wind turbine with a plurality of turbine blades spaced around the turbine's perimeter. A plurality of diverter panels are arranged around the wind turbine in such a way as to divert wind into the turbine blades. An energy generator or pumping mechanism is preferably attached to an axle driven by the wind turbine.

Referring again to FIGS. 1-5, a wind turbine system 10 illustratively includes a plurality of turbine blades 110a-110n being radially spaced and extending vertically, a plurality of diverter panels 210a-210n being respectively adjacent and radially outward of the plurality of turbine blades, a plurality of inner support rings 220, 230 coupled to the plurality of turbine blades, and an axle 114 coupled to the plurality of turbine blades. The wind turbine system 10 illustratively includes a generator 402 coupled to the axle 114, and a frame 403 to be coupled to a surface 404 and carrying the axle and the generator.

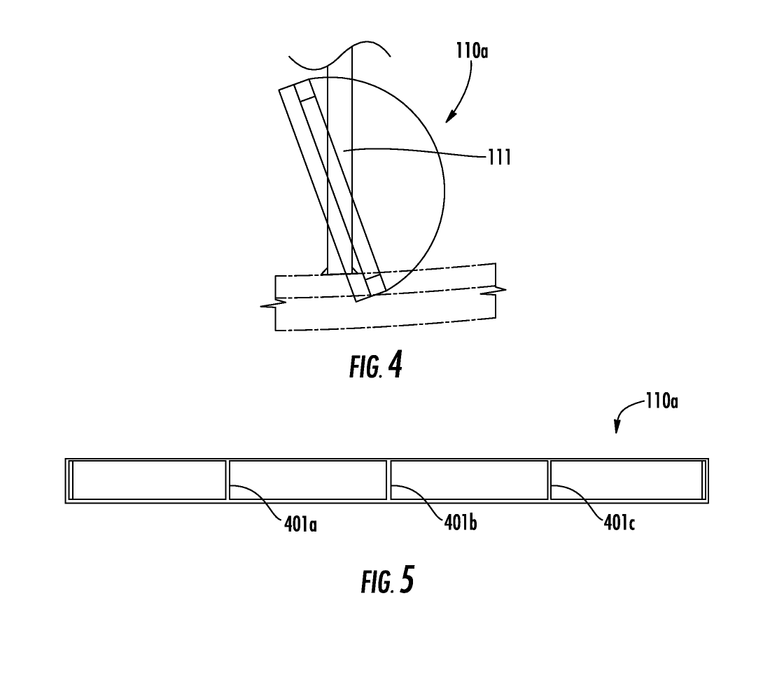

In particular, each diverter panel 210a-210n may be canted at an angle with respect to the respective turbine blade 110a-110n. As perhaps best seen in FIG. 4, each turbine blade 110a-110n may have a semi-cylinder shape. Adjacent diverter panels 210a-210n may define a wind tunnel for the respective turbine blade 110a-110n. As perhaps best seen in FIG. 5, each turbine blade 110a-110n illustratively includes a plurality of support segments 401a-401c extending laterally therein.

In some embodiments, the wind turbine system 10 illustratively includes a hub 405 coupled to the axle 114, and a plurality of blade braces 111, 112 extending radially from the hub respectively to the plurality of turbine blades 110a-110n. Also, each diverter panel 210a-210n may be canted at an angle between 30 degrees and 60 degrees with respect to the respective blade brace 111, 112.

Additionally, the wind turbine system 10 illustratively includes a plurality of outer support rings 211 coupled the plurality of diverter panels 210a-210n. Each diverter panel 210a-210n has opposing first and second longitudinal ends, and the outer support rings 211 include a first outer support ring coupled to the first longitudinal ends of each of the plurality of diverter panels, and a second outer support ring coupled to the second longitudinal ends of each of the plurality of diverter panels. Each turbine blade 110a-110n may have opposing first and second longitudinal ends, and the inner support rings 220, 230 having a first inner support ring coupled to the first longitudinal ends of each of the plurality of turbine blades, and a second inner support ring coupled to the second longitudinal ends of each of the plurality of turbine blades.

Another aspect is directed to a method for making a wind turbine device 10. The method may comprise coupling a plurality of turbine blades 110a-110n to be radially spaced and extend vertically, coupling a plurality of diverter panels 210a-210n to be respectively adjacent and radially outward of the plurality of turbine blades, coupling at least one inner support ring 220, 230 to the plurality of turbine blades, and coupling an axle 114 to the plurality of turbine blades.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A wind turbine device comprising:
a plurality of turbine blades being radially spaced and extending vertically;
a plurality of diverter panels being respectively adjacent and radially outward of said plurality of turbine blades;
at least one inner support ring coupled to said plurality of turbine blades; and
an axle coupled to said plurality of turbine blades.

2. The wind turbine device of claim 1 wherein each diverter panel is canted at an angle with respect to the respective turbine blade.

3. The wind turbine device of claim 1 wherein each turbine blade has a semi-cylinder shape.

4. The wind turbine device of claim 1 wherein adjacent diverter panels define a wind tunnel for the respective turbine blade.

5. The wind turbine device of claim 1 further comprising a hub coupled to said axle, and a plurality of blade braces extending radially from said hub respectively to said plurality of turbine blades.

6. The wind turbine device of claim 5 wherein each diverter panel is canted at an angle between 30 degrees and 60 degrees with respect to the respective blade brace.

7. The wind turbine device of claim 1 further comprising at least one outer support ring coupled to said plurality of diverter panels.

8. The wind turbine device of claim 7 wherein each diverter panel has opposing first and second longitudinal ends; wherein said at least one outer support ring comprises a plurality thereof having a first outer support ring coupled to the first longitudinal ends of each of said plurality of diverter panels, and a second outer support ring coupled to the second longitudinal ends of each of said plurality of diverter panels.

9. The wind turbine device of claim 1 wherein each turbine blade has opposing first and second longitudinal ends; and wherein said at least one inner support ring comprises a plurality thereof having a first inner support ring coupled to the first longitudinal ends of each of said plurality of turbine blades, and a second inner support ring coupled to the second longitudinal ends of each of said plurality of turbine blades.

10. A wind turbine system comprising:
a plurality of turbine blades being radially spaced and extending vertically;
a plurality of diverter panels being respectively adjacent and radially outward of said plurality of turbine blades;
at least one inner support ring coupled to said plurality of turbine blades;
an axle coupled to said plurality of turbine blades;
a generator coupled to said axle; and
a frame to be coupled to a surface and carrying said axle and said generator.

11. The wind turbine system of claim 10 wherein each diverter panel is canted at an angle with respect to the respective turbine blade.

12. The wind turbine system of claim 10 wherein each turbine blade has a semi-cylinder shape.

13. The wind turbine device of claim 10 wherein adjacent diverter panels define a wind tunnel for the respective turbine blade.

14. The wind turbine system of claim 10 further comprising a hub coupled to said axle, and a plurality of blade braces extending radially from said hub respectively to said plurality of turbine blades.

15. The wind turbine system of claim 14 wherein each diverter panel is canted at an angle between 30 degrees and 60 degrees with respect to the respective blade brace.

16. A method for making a wind turbine device, the method comprising:
coupling a plurality of turbine blades to be radially spaced and extend vertically;
coupling a plurality of diverter panels to be respectively adjacent and radially outward of the plurality of turbine blades;
coupling at least one inner support ring to the plurality of turbine blades; and
coupling an axle to the plurality of turbine blades.

17. The method of claim 16 wherein each diverter panel is canted at an angle with respect to the respective turbine blade.

18. The method of claim 16 wherein each turbine blade has a semi-cylinder shape.

19. The method of claim 16 wherein adjacent diverter panels define a wind tunnel for the respective turbine blade.

20. The method of claim 16 further comprising coupling a hub to the axle, and coupling a plurality of blade braces to extend radially from the hub respectively to the plurality of turbine blades.
